(19) United States
(12) Patent Application Publication
(10) Pub. No.: US 2019/0374030 A1
(43) Pub. Date: Dec. 12, 2019

(54) WALL-MOUNT ASSEMBLY

(71) Applicant: LIBERTY HARDWARE MFG. CORP., Winston-Salem, NC (US)

(72) Inventors: James L. DANIELS, Stokesdale, NC (US); Neil EDWARDS, Kernersville, NC (US)

(21) Appl. No.: 16/003,231

(22) Filed: Jun. 8, 2018

(51) Int. Cl. A47B 95/04; F16B 45/00

(52) U.S. Cl. CPC A47B 95/04; F16B 45/00

(57) ABSTRACT

A wall-mount assembly is provided with an elongate rail with at least one receptacle formed into the rail. At least one fastener includes an expandable base, and a flange extending from a proximal end of the expandable base, wherein the flange is sized to pass through the at least one receptacle, and the at least one fastener cooperates with the rail to retain the flange within the at least one receptacle. A method for installing hardware to a wall installs fasteners to a rail. The rail is aligned to the wall. The rail is pressed to the wall such that the fasteners are inserted into the wall. The fasteners are expanded to install the rail and fasteners to the wall.

### TECHNICAL FIELD

Various embodiments relate to wall-mount assemblies.

### BACKGROUND

A wall-mount fastener is illustrated and described in U.S. Pat. No. 4,941,340, which issued to on Jul. 17, 1990 to Vassiliou; E.

### SUMMARY

According to one embodiment, a wall-mount assembly is provided with an elongate rail with at least one receptacle formed into the rail. At least one fastener includes an expandable base, and a flange extending from a proximal end of the expandable base, wherein the flange is sized to pass through the at least one receptacle, and the at least one fastener cooperates with the rail to retain the flange within the at least one receptacle.

According to a further embodiment, the flange is generally square. The at least one receptacle includes a generally square aperture sized to permit the flange to pass through the rail. The expandable base is generally perpendicular to the flange before expansion. The at least one receptacle includes a slot formed through the rail that intersects the rectangular aperture and sized to permit the expandable base to extend through the slot. An aperture is formed through the flange sized to receive a threaded fastener. The expandable base collectively defines a boss sized to receive the threaded fastener. The at least one receptacle further includes a round aperture formed through the rail, intersecting the slot and sized to receive the boss. The wall-mount assembly further includes a retainer extending from the rail adjacent to the slot to engage the flange and limit translation of the flange from the slot. The retainer further includes a projection extending from the rail and interfering with a range of travel between the rectangular aperture and the slot. The slot is formed through the retainer, and the projection further comprises a pair of projections oriented on opposed sides of the slot.

According to an even further embodiment, an ornamental mounting plate is fixed to the elongate rail, where the ornamental mounting plate includes a plurality of hooks. The embodiment also includes a plurality of fasteners to fasten the plurality of hooks to the mounting plate and the elongate rail.

According to another embodiment, a method for installing hardware to a wall installs fasteners to a rail. The rail is aligned to the wall. The rail is pressed to the wall such that the fasteners are inserted into the wall. The fasteners are expanded to install the rail and fasteners to the wall.

According to an even further embodiment, a method for installing the hardware where the fasteners, including a flange and an expandable base, are provided before installing the fasteners to the rail. The flange of each fastener is then inserted into an aperture in the rail. The method further includes a step where the expandable base of each fastener is slid into a slot intersecting the aperture thereby installing the fasteners to the rail. The expandable base of each fastener is slid from a slot in the rail to an intersecting aperture. The flange of each fastener is then passed through an aperture to uninstall the fastener from the rail. The threaded fastener is then installed into the expandable fastener to thereby expand the expandable fastener and fasten the hardware to the wall.

According to a further embodiment, an elongate rail with at least one receptacle formed into the rail. At least one fastener including an expandable base, and a flange extending from a proximal end of the expandable base, wherein the flange is sized to pass through the at least one receptacle, and the at least one fastener cooperates with the rail to retain the flange within the at least one receptacle;

According to an even further embodiment, the flange is generally rectangular. The at least one receptacle includes a generally rectangular aperture sized to permit the flange to pass through the rail. The expandable base is generally perpendicular to the flange before the expansion. The at least one receptacle includes a slot formed through the rail that intersects the rectangular aperture and sized to permit the expandable base to extend through the slot. An aperture is formed through the flange sized to receive a threaded fastener, and wherein the expandable base collectively defines a boss sized to receive the threaded fastener. The at least one receptacle further includes a round aperture formed through the rail, intersecting the slot and sized to receive the boss. A retainer extends from the rail adjacent to the slot to engage the flange and limit translation of the flange from the slot. The retainer further includes a projection extending from the rail and interfering with a range of travel between the rectangular aperture and the slot. The slot is formed through the retainer, and the projection further includes a pair of projections oriented on opposed sides of the slot.

### BRIEF DESCRIPTION OF THE DRAWINGS

FIG. 1 is a front perspective view of a wall-mount assembly according to an embodiment;

FIG. 2 is a rear perspective view of the wall-mount assembly of FIG. 1;

FIG. 3 is a front exploded view of the wall-mount assembly of FIG. 1;

FIG. 4 is a side partial section view of the wall-mount assembly of FIG. 1, illustrated installed to a wall;

FIG. 5 is an enlarged partial rear perspective of the wall-mount assembly of FIG. 1, illustrating a disassembly step;

FIG. 6 is a front side view of a rail of the wall-mount assembly of FIG. 1, according to an embodiment;

FIG. 7 is an enlarged front side view of a receptacle of the rail of FIG. 6; and

FIG. 8 is a top section view of the rail taken along section line 8-8 in FIG. 7.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Conventional wall-mount assemblies typically require an end user to drill holes with an electronic or battery powered drill to properly size fasteners into the wall-mount and wall. Therefore, options for wall-mount assemblies are limited and oftentimes impractical for end user who do not have the appropriate tools. This new embodiment eliminates the need for these tools, since the fasteners set forth can be pressed directly into the wall with minimal effort.

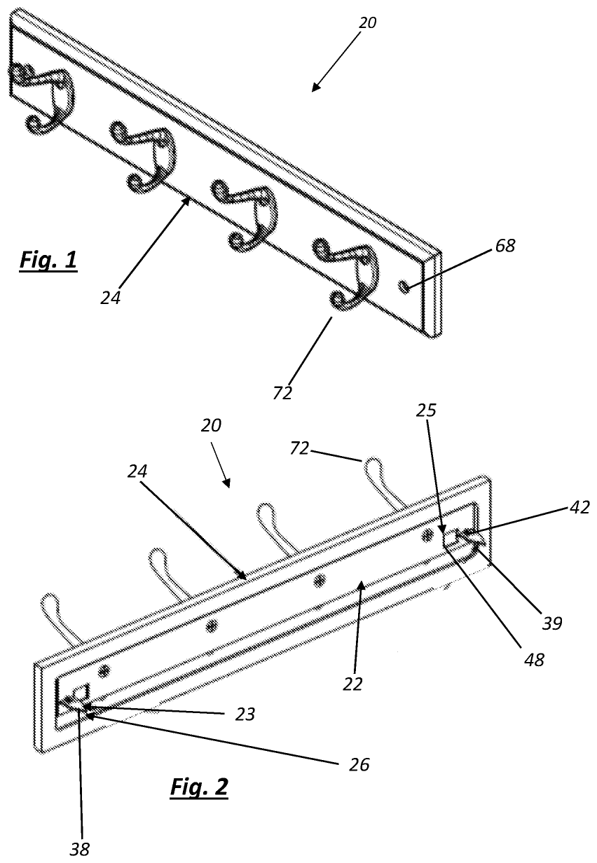

With reference now to FIGS. 1-3, a wall-mount assembly 20 is illustrated. The wall-mount assembly 20 is depicted as a hook rail assembly 20 according to an embodiment. Although the hook rail assembly 20 is illustrated, any wall-mount assembly 20 is contemplated, such as a mirror assembly, a picture assembly, or the like.

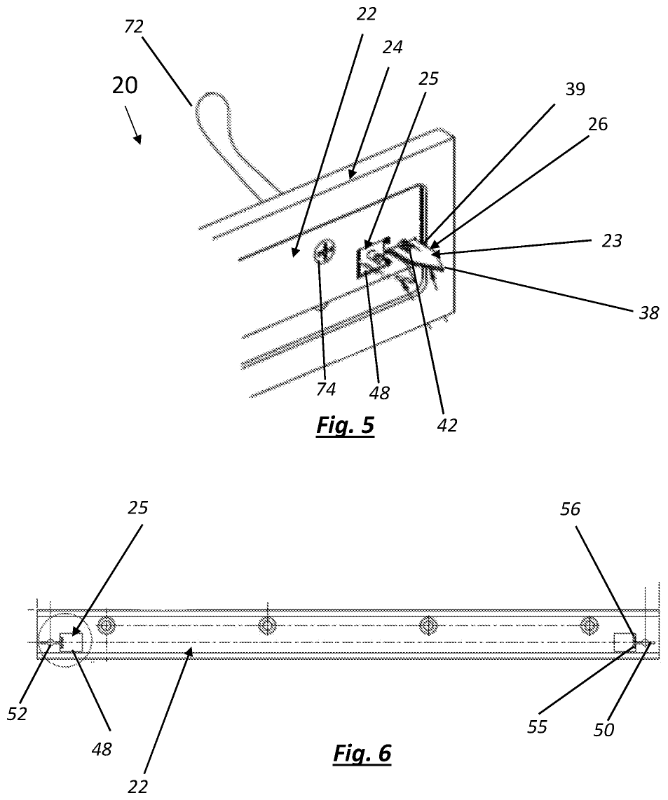

With reference now to FIGS. 2, 3, 5 and 6, a rail 22 is illustrated according to an embodiment. The rail 22 is an elongate structural support member for supporting the wall-mount assembly 20 and for attachment to the wall. The rail 22 is formed from a suitable structural material, such as a metal alloy, and may be formed from an extrusion or forging process, or the like.

The rail 22 cooperates with a plurality of fastener assemblies 23, such as a pair of drywall anchor assemblies 23 to mount the rail 22 and consequently, the wall-mount assembly 20 to the wall. A mounting plate 24 is mounted to the rail 22 to enclose the rail 22 and to be supported by the rail 22 upon the wall. The mounting plate 24 may be formed from wood, a polymeric material, or any suitable ornamental, structural material.

The rail 22 is formed with a plurality of, such as a pair of, receptacles 25 to cooperate with the fastener assemblies 23. Each receptacle 25 engages one of the fastener assemblies 23 to secure the rail 22 to the support surface. With reference now to FIGS. 2-5, the fastener assembly 23 is illustrated according to an embodiment. The fastener assembly 23 includes a fastener, such as a drywall anchor 26. The drywall anchor 26 is shaped as a flat tack that is expandable to be first inserted into the drywall, and second expanded to lock into the drywall. Drywall anchors 26 are well known in the art, and may embody various shapes, sizes, and any suitable configuration.

The drywall anchor 26 includes an expandable base 38 and a flange 40. The expandable base 38 perpendicularly intersects the flange 40. The expandable base 38 and the flange 40 may be collectively formed from a single stamped piece of metal. The expandable base 38 may be defined by a pair of elongate and flat tacks 39 that are oriented generally parallel to each other. The flat tacks 39 collectively define a boss 42 sized to receive a threaded fastener 44. Although the threaded fastener 44 is illustrated, any suitable fastener is contemplated.

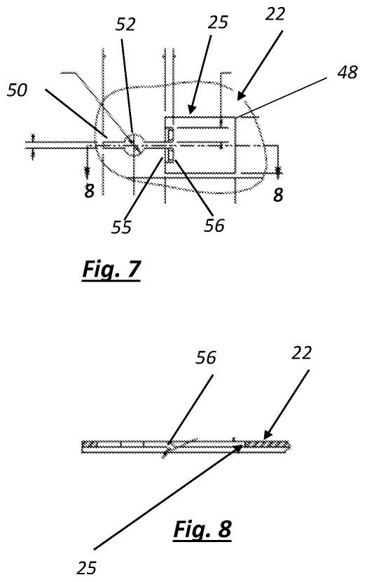

The flange 40 of the drywall anchor 26 extends from a proximal end of the expandable base 38. Flanges 40 of drywall anchors 26 are typically formed with a square profile. As illustrated in FIGS. 2, 3, and 5-8, the receptacle 25 depicted includes a rectangular aperture 48 that is sized to receive the rectangular flange 40. Although a rectangular aperture 48 is illustrated and described, any shape aperture is contemplated. The receptacle 25 cooperates with the drywall anchor 26 to retain the flange 40 and consequently the fastener assembly 23.

For example, the rectangular aperture 48 is intersected by a slot 50 formed through the rail 22. The slot 50 is sized to receive the collapsed tacks 39 of the expandable base 38. The receptacle 25 also includes a round aperture 52 intersecting the slot 50. The round aperture 52 provides clearance for the boss 42 of the expandable base 38. The round aperture 52 also provides clearance for the threaded fastener 44.

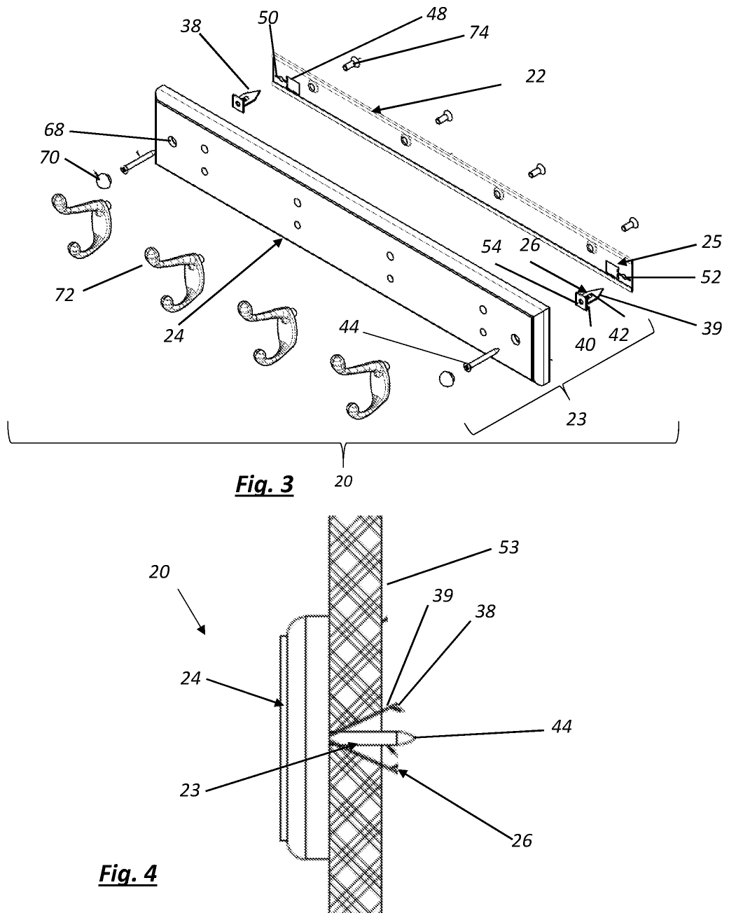

With reference now to FIG. 3, the wall mount assembly 20 is illustrated in exploded view, including the fastener assemblies 23. The drywall anchor 26 may be installed directly into the rail 22 prior to assembly of the mounting plate 24 to the rail 22. For example, this installation may be performed by the manufacturer to reduce or avoid this step at installation by the end user. In such installation, the tacks 39 of each expandable base 38 are aligned with the corresponding slot 50. Likewise, the bosses 42 are aligned with the round aperture 52. The tacks 39 are inserted into each slot 50 with the bosses 42 passing through each round aperture 52. Upon installation of the tacks 39 into the wall, the tacks 39 temporarily secure the drywall anchors 26, the rail 22, and the mounting plate 24 to the wall.

Alternatively, the drywall anchor 26 may be fastened to the rail 22 after the mounting plate 24 is fastened to the rail 22. In this situation, the flange 40 is inserted into the rectangular aperture 48. Then the expandable base 38 is aligned with the slot 50, and the drywall anchor 26 is translated so that the expandable base 38 is received within the slot 50.

The end user determines a location to attach the wall-mount assembly 20 on the wall 53. The end user then presses the mounting plate 24 with the expandable base 38 end first into the wall 53, until the rail 22 engages the wall 53. The end user can utilize a level during the installation process. The installation process removes the steps of drilling pilot holes into the wall 53 and inserting drywall anchors into the drilled holes in the wall 53. The installation process also removes the steps of aligning the round aperture 52 in the rail 22 with drywall anchors in the wall 53, and then, inserting threaded fasteners into the round aperture 52 and the drywall anchors.

Referring now to FIG. 4, the wall mount assembly 20 is illustrated fastened to a wall 53. After insertion of the tacks 39 into the wall 53, the pair of threaded fasteners 44 are driven into the drywall anchors 26. The threaded fasteners 44 engage a threaded aperture 54 in the flange 40. This engagement causes the threaded fasteners 44 to extend within the bosses 42 between the tacks 39. As the threaded fasteners 44 extend further within the expandable base 38, the tacks 39 are driven to diverge outward as illustrated in FIG. 4. The expanded tacks 39 engage the drywall of the wall 53 thereby securing the fastener assemblies 23 and consequently, the rail 22 and the wall-mount assembly 20 to the wall 53.

As depicted in FIGS. 6-8, the rail 22 includes a retainer 55 adjacent to the slot 50. The retainer 55 is utilized to retain the drywall anchor 26 within the slot 50. The retainer 55 includes a pair of projections 56 oriented on opposed sides of the slot 50, with the slot 50 passing therethrough. The projections 56 extend in a direction away from the wall 53 to provide an interference to the flange 40 and to limit inadvertent translation of the drywall anchor 26.

The end user may still use the wall-mount assembly 20 if a situation arises where both drywall fasteners 26 are not required. For example, a stud may be provided behind the wall 53 that would otherwise hinder the use of the drywall anchor 26. The drywall anchor 26 can be removed from the rail 22 by urging the drywall anchor 26 against the bias of the retainer 55 while sliding the expandable base 38 and consequently the boss 42 along the slot 50, and past the round aperture 52. The boss 42 of the expandable base 38 disengages at the retainer 55, allowing the fastener 26 to enter into the rectangular aperture 48. The fastener 26 is then released from the rectangular aperture 48 with the flange 40. In order to fasten the wall-mount assembly 20 into a stud, the end user inserts the threaded fastener 44 into the mounting plate 24 through an aperture 68 and through the rail 22 at the round aperture 52. The threaded fastener 44 then penetrates the dry wall and fastens to the stud.

Referring now to FIG. 3, a pair of decorative fastener caps 70 may be provided to cover the threaded fasteners 44 according to an embodiment. A plurality of hooks 72 are mounted to the rail 22 and mounting plate 24 by threaded fasteners 74 that extend through the rail 22 and the mounting plate 24 and into the hooks 72. Although hooks 72 are illustrated and described, any wall-mount hardware is contemplated.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A wall-mount assembly comprising:
an elongate rail with at least one receptacle formed into the rail; and
at least one fastener comprising an expandable base, and a flange extending from a proximal end of the expandable base, wherein the flange is sized to pass through the at least one receptacle, and the at least one fastener cooperates with the rail to retain the flange within the at least one receptacle.

2. The wall-mount assembly of claim 1 wherein the flange is generally square;
wherein the at least one receptacle includes a generally rectangular aperture sized to permit the flange to pass through the rail;
wherein the expandable base is generally perpendicular to the flange before expansion;
wherein the at least one receptacle includes a slot formed through the rail that intersects the rectangular aperture and sized to permit the expandable base to extend through the slot;
wherein an aperture is formed through the flange sized to receive a threaded fastener, and wherein the expandable base collectively defines a boss sized to receive the threaded fastener;
wherein the at least one receptacle further includes a round aperture formed through the rail, intersecting the slot and sized to receive the boss;
wherein the wall-mount assembly further comprises a retainer extending from the rail adjacent to the slot to engage the flange and limit translation of the flange from the slot;
wherein the retainer further comprises a projection extending from the rail and interfering with a range of travel between the rectangular aperture and the slot; and
wherein the slot is formed through the retainer, and the projection further comprises a pair of projections oriented on opposed sides of the slot.

3. The wall-mount assembly of claim 1 wherein the flange is generally rectangular; and
wherein the at least one receptacle includes a generally rectangular aperture sized to permit the flange to pass through the rail.

4. The wall-mount assembly of claim 3 wherein the expandable base is generally perpendicular to the flange before expansion; and
wherein the at least one receptacle includes a slot formed through the rail intersecting the rectangular aperture and sized to permit the expandable base to extend through the slot.

5. The wall-mount assembly of claim 4 wherein an aperture is formed through the flange sized to receive a threaded fastener, and wherein the expandable base collectively defines a boss sized to receive the threaded fastener; and
wherein the at least one receptacle further includes a round aperture formed through the rail, intersecting the slot and sized to receive the boss.

6. The wall-mount assembly of claim 4 further comprising a retainer extending from the rail adjacent to the slot to engage the flange and limit translation of the flange from the slot.

7. The wall-mount assembly of claim 6 wherein the retainer further comprises a projection extending from the rail and interfering with a range of travel between the rectangular aperture and the slot.

8. The wall-mount assembly of claim 7 wherein the slot is formed through the retainer, and the projection further comprises a pair of projections oriented on opposed sides of the slot.

9. The wall-mount assembly of claim 1 further comprising an ornamental mounting plate on the elongate rail.

10. The wall-mount assembly of claim 9 further comprising a plurality of hooks mounted to the ornamental mounting plate.

11. The wall-mount assembly of claim 10 further comprising a plurality of threaded fasteners to fasten the plurality of hooks to the mounting plate.

12. The wall-mount assembly of claim 11 wherein the plurality of threaded fasteners fastens the plurality of hooks to the mounting plate and the elongate rail.

13. A method for installing hardware to a wall, the method comprising:
installing fasteners to a rail;
aligning the rail to the wall;
pressing the rail to the wall such that the fasteners are inserted into the wall; and
expanding the fasteners to install the rail and fasteners to the wall.

14. The method of claim 13 further comprising a step of providing fasteners with a flange and an expandable base before installing the fasteners to the rail.

15. The method of claim 14 further comprising a step of inserting the flange of each fastener into an aperture in the rail.

16. The method of claim 15 further comprising a step of sliding the expandable base of each fastener into a slot intersecting the aperture thereby installing the fasteners to the rail.

17. The method of claim 14 further comprising a step of sliding the expandable base of each fastener from a slot in the rail to an intersecting aperture.

18. The method of claim 17 further comprising a step of passing the flange of each fastener through an aperture to uninstall each fastener from the rail.

19. The method of claim 13 further comprising installing a threaded fastener into the expandable fastener to thereby expand the expandable fastener and fasten the hardware to the wall.

20. A wall-mount assembly comprising:
an elongate rail with at least one receptacle formed into the rail;
at least one fastener comprising an expandable base, and a flange extending from a proximal end of the expandable base, wherein the flange is sized to pass through the at least one receptacle, and the at least one fastener cooperates with the rail to retain the flange within the at least one receptacle;
wherein the flange is generally rectangular;
wherein the at least one receptacle includes a generally rectangular aperture sized to permit the flange to pass through the rail;
wherein the expandable base is generally perpendicular to the flange before expansion;
wherein the at least one receptacle includes a slot formed through the rail that intersects the rectangular aperture and sized to permit the expandable base to extend through the slot;
wherein an aperture is formed through the flange sized to receive a threaded fastener, and wherein the expandable base collectively defines a boss sized to receive the threaded fastener;
wherein the at least one receptacle further includes a round aperture formed through the rail, intersecting the slot and sized to receive the boss;
a retainer extending from the rail adjacent to the slot to engage the flange and limit translation of the flange from the slot;
wherein the retainer further comprises a projection extending from the rail and interfering with a range of travel between the rectangular aperture and the slot; and
wherein the slot is formed through the retainer, and the projection further comprises a pair of projections oriented on opposed sides of the slot.
